(19) United States
(12) Patent Application Publication
(10) Pub. No.: US 2020/0019597 A1
(43) Pub. Date: Jan. 16, 2020

(54) Providing Nutritional Information From Recipe Images

(71) Applicant: Kenneth Leeser, Boston, MA (US)

(72) Inventor: Kenneth Leeser, Boston, MA (US)

(21) Appl. No.: 16/510,767

(22) Filed: Jul. 12, 2019

Related U.S. Application Data
(60) Provisional application No. 62/696,946, filed on Jul. 12, 2018.

(51) Int. Cl. G06F 17/24; G06K 9/00; G06K 9/20; G06F 16/583; G09B 19/00

(52) U.S. Cl. CPC G06F 17/24; G06K 9/00469; G06K 2209/01; G06F 16/5846; G09B 19/0092; G06K 9/2054

(57) ABSTRACT

Systems and methods for providing nutritional information from recipe images are provided. The system comprises one or more of: a database of recipe disambiguation data, a processor, a database of nutritional information, a memory, an input/output for communicating with external databases and with user devices, and computer-readable instructions for carrying out the inventive methods. The present invention improves on current art for providing nutritional information from recipe images. The present invention solves technical problems that exist in assessing nutritional information of a recipe, by providing for user input of recipe content from any image, optical character recognition of recipe content from any image, and disambiguation of language used in recipes.

### FIELD OF THE INVENTION

The presently disclosed subject matter relates to providing nutritional information from recipe images, and more specifically, by acquiring images, assessing the information in images and proofing that recipe information within the invention and with user input, searching internal and/or external databases of nutritional information, and assessing the nutritional information of the recipe.

### BACKGROUND OF THE INVENTION

The current state of generating nutritional information from recipe images allows users to use images, including content found online, to generate nutritional information, but introduces errors. The errors relate to encompassing irrelevant information, not providing for user input to correct the area of an image or webpage scanned to acquire recipe information, and not adjusting the nutritional information based on the subtleties and ambiguities inherent in the language used by authors to describe cooking. Such ambiguities and subtleties of language relate to cooking temperatures and times, and to amounts of ingredients. By not recognizing and adjusting for these natural-language variations and ambiguities used in the phrasing that describes recipes, the current art introduces shortcomings in providing nutritional information from recipe images. The current art does not accept user input well in parsing ingredients and assigning nutritional values to each, and the current art does not customize the nutritional information based on the ambiguities used in the language of recipes.

### SUMMARY OF THE INVENTION

The present invention meets all these needs, by disclosing systems, and methods, and instructions stored in non-transitory computer-readable media, for providing nutritional information from recipe images. One goal of the present invention is to provide a solution for more efficient acquisition of images, from a range of sources, to be used to scan for the recipe information, using optical character recognition (OCR) technology. Another goal of the present invention is to use the recipe information and one or more databases of nutritional information to ascribe nutritional information to the recipe and a typical serving. A further goal of the present invention is to assess the recipe information and adjust for ambiguities in the language used to describe the recipe, the ingredients, and the amounts. Another goal of the present invention is to allow user input to select the areas of images to be used to acquire recipe information, and to use user input to adjust and select the ingredients that appear to be in the recipe.

In one aspect, the present invention comprises a method, stored in non-transitory computer-readable media, for a system providing nutritional information from recipe images, by acquiring images with a system image acquisition method module, assessing images with a system image assessment method module, and assessing nutritional information with a system nutritional assessment method module, the method comprising the system acquires an image, and displays the image to a user device used by a user; then the system carries out first a marking step, in which the system accepts some marking of an area of the image; then the system performs OCR on the relevant area, generating a plurality of ingredients as recipe information; then the system performs proofing on the recipe information; then the system presents the recipe information to the user device; and then the system accepts edits to the recipe information from the user device.

In one aspect, the present invention comprises a method in which the system conducts conversions to change the amounts of each ingredient in the plurality of ingredients between one or more systems of measurement.

In one aspect, the present invention comprises a method in which the system disambiguates amounts which are relative terms.

In one aspect, the present invention comprises a method in which the user inputs additional information on ingredients and nutritional information, including but not limited to information on ingredients not present in the recipe information, and the system accepts such additional information.

In one aspect, the present invention comprises a method in which after the system accepts edits to the recipe information from the user device, the system checks the content of the recipe information; then the system searches for each ingredient from the plurality of ingredients, and thereafter accepts edits to each ingredient from the plurality of ingredients; then the system calculates nutritional information from information in one or more of the databases, the first external database, the second external database, and any other external databases; thereafter, the system presents the nutritional information for the recipe information to the user using the user device.

In one aspect, the present invention comprises a method stored in non-transitory computer-readable media, for a user device to provide nutritional information from recipe images, by acquiring images with a UD image acquisition method module, assessing images with a UD image assessment method module, and assessing nutritional information with a UD nutritional assessment method module, the method comprising the user device sends an image to the system, and thereafter receives an image from the system; then the user device takes edits of the image from a user of the user device, and then transmits edits of the image to the system; and then the user device receives initial recipe information from the system, and thereafter takes and transmits recipe edits, to the recipe information, to the system.

In one aspect, the present invention comprises a method in which the user inputs additional information on ingredients and nutritional information, including but not limited to information on ingredients not present in the recipe information, and the user device takes and transmits to the system such additional information along with the recipe edits.

In one aspect, the present invention comprises a method in which the edits of the image from a user comprise marking by the user to indicate the area of the image that is of interest to the user for the recipe information.

In one aspect, the present invention comprises a method in which, after the user device takes and transmits recipe edits, to the recipe information, to the system, the user device receives ingredient matches from the system and presents them to the user; then the user may select one or more of the plurality of ingredients as the plurality of ingredients that belong in the recipe information; then the user device sends a user selection of the plurality of ingredients to the system; then the user device receives nutritional information, the nutritional information being the assessed information for the recipe and ingredients as selected by the user.

In one aspect, the present invention comprises a method, stored in non-transitory computer-readable media, for a user device and a system to provide nutritional information from recipe images, by acquiring images with a third-party-view acquisition method module, assessing images with a third-party-view image assessment method module, and assessing nutritional information with a third-party-view nutritional assessment method module, the method comprising the user device sends an image, and thereafter, the system receives the image; then the system sends an image to the user device, and the user device receives the image; thereafter the system sends an image, and the user device receives the image; then the user device sends edits of the image to the system, and the system receives edits of the image; thereafter the system sends an initial recipe to the user device, and the user device receives the initial recipe from the system; later, the user device transmits recipe edits to the system, and the system receives the recipe edits from the user device.

In one aspect, the present invention comprises a method in which, after the system receives the recipe edits from the user device, the system sends ingredient matches to the user device, and the user device receives ingredient matches from the system, thereafter, the user device sends the user selection of ingredients from the plurality of ingredients, and the system receives the user selection of the plurality of ingredients; then the system sends nutritional information to the user device, and the user device receives nutritional information from the system.

In one aspect, the present invention comprises a method in which the user selection of ingredients from the plurality of ingredients comprise additional information on ingredients and nutritional information, including but not limited to information on ingredients not already present in the plurality of ingredients or in the user selection.

In one aspect, the present invention comprises a method in which the recipe edits comprise user input of additional information on ingredients and nutritional information, including but not limited to information on ingredients not present in the initial recipe.

In one aspect, the present invention comprises a system for providing nutritional information from recipe images, the system comprising at least one processor, at least one database, at least one memory, at least one input/output port, and computer-readable instructions stored in non-transitory computer-readable media configured to carry out the various elements of the inventive methods; and wherein the database contains nutritional information related to a plurality of ingredients; the system communicates with at least one user device, which user device acquires an image of a recipe; the system obtains recipe information from the image using optical character recognition technology; the system communicates with a first external database, a second external database, or any number of external databases, which external databases contain nutritional information.

In one aspect, the present invention comprises a system in which the user device accesses the Internet using web-browsing software that is built as part of the system.

In one aspect, the present invention comprises a system in which the image of a recipe is a photograph taken by the user device.

In one aspect, the present invention comprises a system in which the image of a recipe is a photograph taken an external camera connected to the user device.

In one aspect, the present invention comprises a system in which the image of a recipe is an image already present on the user device or accessed by the user device.

In one aspect, the present invention comprises a system in which the image of a recipe is accessed on the Internet by the user device.

In one aspect, the present invention comprises computer-readable instructions, stored in non-transitory computer-readable media, for providing nutritional information from recipe images, the computer-readable instructions comprising controlling a system and a user device to take a recipe image, comprising recipe information, scan the recipe image for a plurality of recipe information, using optical character recognition technology, and use the recipe information and one or more databases of nutritional information to ascribe nutritional information to the recipe.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various aspects, is better understood when read in conjunction with the appended drawings. For the purposes of illustration, there is shown in the drawings exemplary aspects; but the presently disclosed subject matter is not limited to the specific methods and instrumentalities disclosed. In the drawings, like reference characters generally refer to the same components or steps of the device throughout the different figures. In the following detailed description, various aspects of the present invention are described with reference to the following drawings, in which:

FIG. 1 illustrates elements of the inventive system, in the environment in which it operates.

FIG. 2 shows a schematic drawing of certain modules of the system.

FIG. 3 shows a schematic drawing of an aspect of an inventive method of the present invention, from the perspective of the system.

FIG. 4 shows a schematic drawing of an aspect of an inventive method of the present invention, from the perspective of a user device interacting with the system.

FIG. 5 shows a schematic drawing of an aspect of an inventive method of the present invention, from the perspective of a third party observing interactions between the system and a user device.

FIG. 6 illustrates certain aspects of the system and methods for providing nutritional information from recipe images.

FIG. 7 shows a dataflow diagram of an aspect of the present invention.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the methods and systems of the present invention.

The present subject matter discloses systems and methods for providing nutritional information from recipe images. At a high level of overview, the present invention presents systems and methods to acquire images, take input related to recipe information in the images, assess whether there is recipe information in the images, assess the nutritional content of the recipe information to arrive at nutritional information, and present that nutritional information to a user device. The systems and methods provide for acquisition of images from a range of sources, for flexible assessment of images using input received from a user using a user device, including use of OCR technology, for nutritional assessment using a plurality of databases of nutritional information, and presentation of calculated nutritional information to the user device. The inventive systems and methods, as described below in greater detail, carry out these functions of providing nutritional information from recipe images.

In the following descriptions of the inventive methods of the present disclosure, reference is made to structures and components of the system 100; for further description of such structures and components, refer to the discussion of the figures, below.

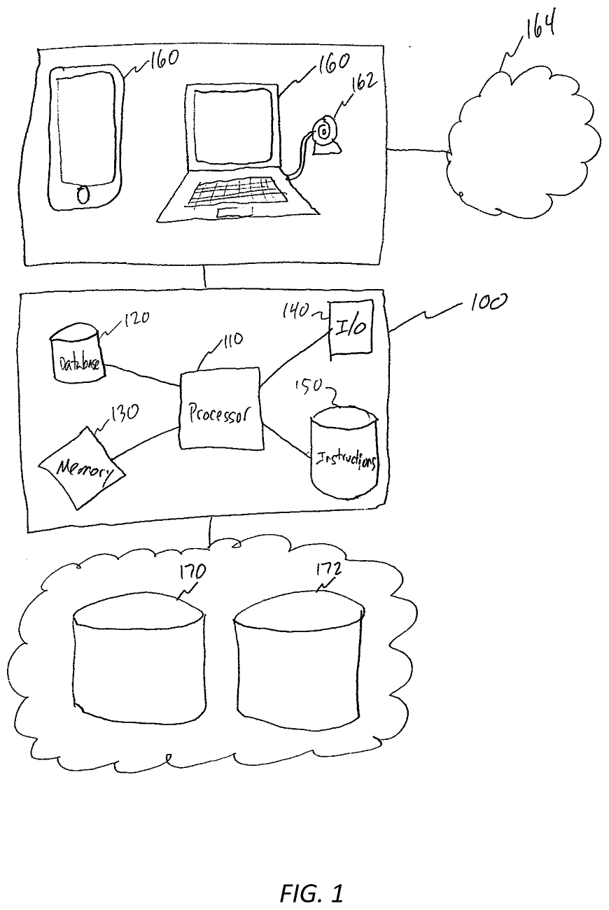

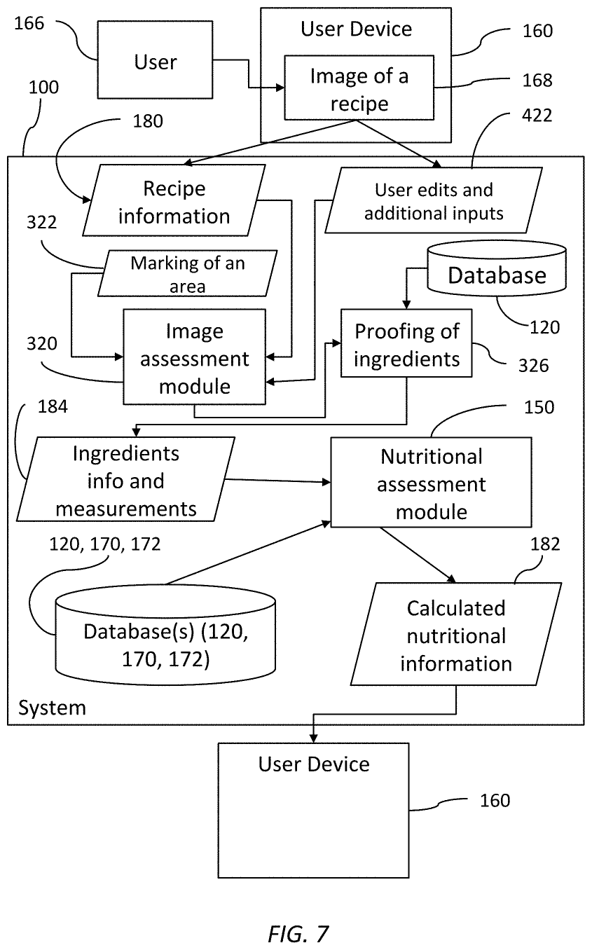

FIG. 1 illustrates elements of an exemplary system 100 configured to implement and carry out the methods of the present invention, in the environment in which the system operates. The system 100 comprises at least one processor 110, at least one database 120, at least one memory 130, at least one input/output 140 port, and computer-readable instructions 150 stored in non-transitory computer-readable media configured to carry out the various elements of the inventive methods, namely to take a recipe image 168, comprising recipe information 180, scan the recipe image 168 for a plurality of recipe information 180, using optical character recognition technology, and use the recipe information 180 and one or more databases of nutritional information 120, 170, and/or 172 to ascribe nutritional information 182 to the recipe. Collectively, these are the components of the system 100. The foregoing components are in operative communication with each other in the system 100, and throughout steps of the methods of the present invention, the foregoing components communicate and share data. The database 120 may contain nutritional information 182 related to a plurality of ingredients 184, and/or may contain information for disambiguation of language used in recipes, including but not limited to words and phrases for amounts, such as a “pinch,” a “splash,” and “to-taste,” in which any one phrase may be disambiguated to different amounts for each ingredient in the plurality of ingredients 184. FIG. 7 shows an exemplary flow of data, in a dataflow diagram, through the system 100 and the user device 160 and other illustrated elements of the present invention, illustrating the communication of the system 100 and the user device 160, and the transformation and creation of the image 168, the recipe information 180, the nutritional information 182, and/or the plurality of ingredients 184.

In the environment in which the system 100 operates, the system 100 communicates with at least one user device 160. The user device 160 is used to acquire an image 168 of a recipe for the system 100 to use, following the methods of the present invention. An image 168 of a recipe may be a photograph taken by the user device 160, or by an external camera 162 connected to the user device 160, in operation of the system 100 of the present invention, or an image 168 already present on the user device 160 or accessed by the user device 160, or the image 168 of the recipe may be accessed on the Internet 164 by the user device 160. In some aspects of the present invention, the user device 160 may access the Internet 164 using web-browsing software that is built as part of the system 100 operating on or in communication with the user device 160; in other aspects of the present invention the system 100 may not include web-browsing software, and must use a web browser that is on or accessible by the user device 160. The image 168 may be partly text, or may be a text file, or may in some aspects of the present invention be a still frame or grab from a video or other moving image, including but not limited to a gif. The system 100 may obtain recipe information 180 from the image 168 using optical character recognition (OCR) technology. The user 166 may provide input on the image 168, as well, as will be described below in greater detail.

The system 100 may also communicate with a first external database 170, a second external database 172, or any number of external databases. Such external databases may contain nutritional information 182 accessed by the system 100. The computer-readable instructions 150, or a subset thereof, are stored in non-transitory computer-readable memory 130 in the system 100.

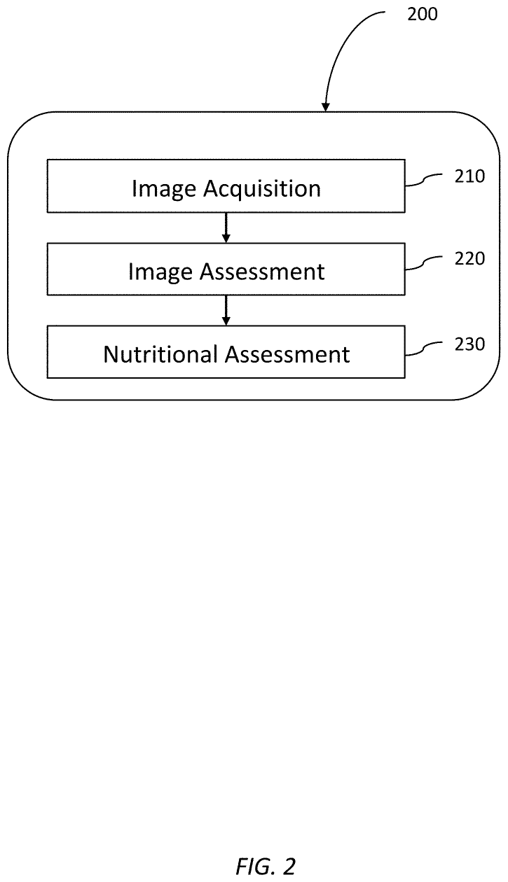

With reference to FIG. 2, the system 100 implements system modules 200 to carry out methods that, at a high level of overview, comprise an image acquisition module 210, an image assessment module 220, and a nutritional assessment module 230. These system modules 200 are used in the implementation of the inventive methods, to acquire images 168 with the image acquisition module 210, assess images 168 with the image assessment module 220, and assess nutritional information 182 with the nutritional assessment module 230.

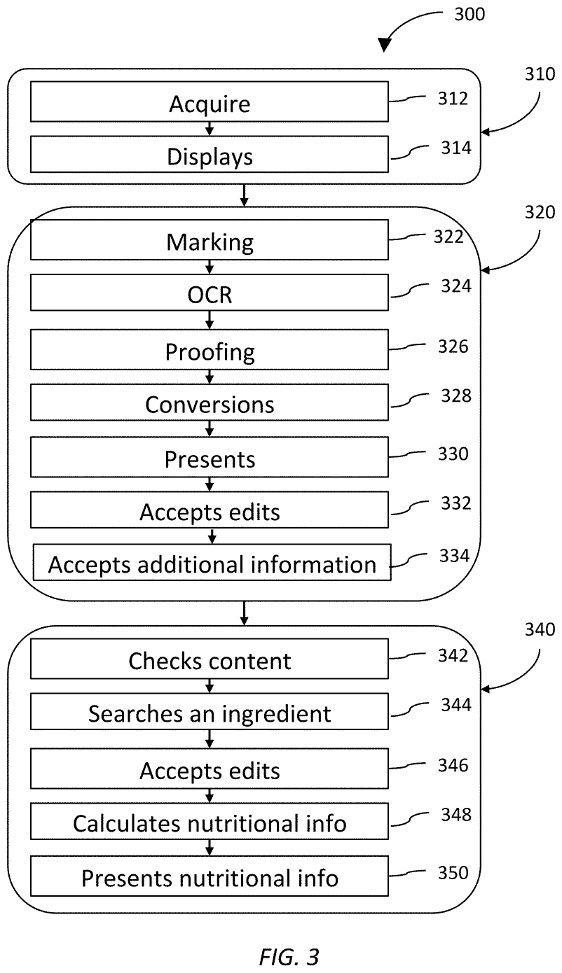

With reference to FIG. 3, the inventive method 300 of the present invention from the perspective of the system 100 is presented. The method 300 comprises a system image acquisition method module 310, a system image assessment method module 320, and a system nutritional assessment method module 340. The system acquisition method module 310 comprises steps in which the system 100 acquires 312 an image 168, and displays 314 the image 168 to the user device 160. In the system image assessment method module 320, the system 100 carries out first a marking 322 step, in which the system 100 may accept some marking 322 of an area of the image 168 as the relevant area containing the basis of the recipe information 180 desired by the user 166 of the user device 160. The system 100 may then perform OCR 324 on the relevant area containing recipe information 180, to obtain the recipe information 180 in standard-character form, as opposed to image data, including but not limited to a plurality of ingredients 184. The system 100 may then perform proofing 326 on the recipe information 180, and may conduct conversions 328 to change the amounts of each ingredient in the plurality of ingredients 184 between one or more systems of measurement, including but not limited to Imperial (English) measurement and the metric system, and by disambiguating amounts which are relative terms, such as a “pinch,” a “splash,” or “to taste.” Thereafter, the system 100 presents 330 the recipe information 180 to the user device 160, and the system 100 accepts edits 332 to the recipe information 180, if any, from the user 166 of the user device 160. In some aspects of the present invention, the user 166 may input additional information on ingredients and nutritional information, including but not limited to information on ingredients not present in the recipe information 180, and the system 100 accepts 334 such additional information.

The system nutritional assessment method module 340 comprises steps in which the system 100 checks the content 342 of the recipe information 180 to confirm that it does appear to be a recipe, including but not limited to checking that items listed appear to be food ingredients from a plurality of ingredients 184 listed with amounts. The system 100 thereafter searches 344 for each ingredient from the plurality of ingredients 184, and thereafter accepts edits 346 to each ingredient from the plurality of ingredients 184, including edits to the type of ingredient and the amount of each, from the user device 160. In some aspects of the present invention, the user 166 may thereafter input additional information on ingredients and nutritional information 182, including but not limited to information on ingredients not already present in the plurality of ingredients 184. The system then calculates 348 nutritional information 182 from information in one or more of the databases 120, the first external database 170, the second external database 172, and any other external databases. Thereafter, the system 100 presents 350 the nutritional information 182 for the recipe information 180 to the user 166 using the user device 160.

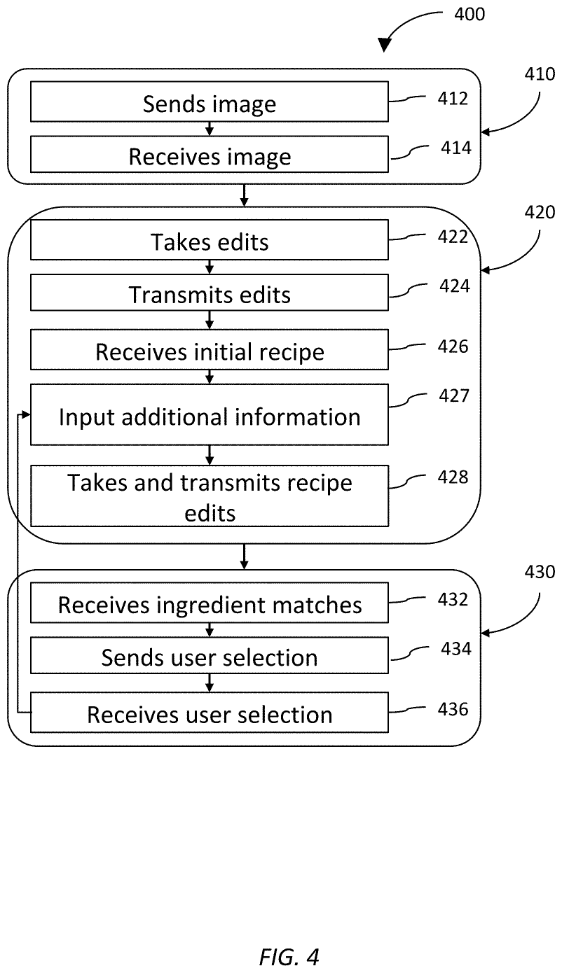

FIG. 4 presents a view of certain aspects of the inventive method 400 of the present invention from the perspective of the user device 160, for the user device 160 to provide nutritional information 182 from recipe images 168. The method 400 comprises a UD acquisition method module 410, a UD image assessment method module 420, and a UD nutritional assessment method module 430. The UD acquisition method module 410 comprises steps in which the user device 160 sends 412 an image 168 to the system 100, and thereafter receives 414 an image 168 from the system 100. In the UD image assessment method module 420, the user device 160 takes edits 422 of the image 168 from the user 166 of the user device 160, and then transmits edits 424 of the image 168 to the system 100. In some aspects of the present invention, the edits 422 may comprise some marking by the user 166 to indicate the area of the image 168 that is of interest to the user 166 for the recipe information 180. Later, the user device 160 receives initial recipe 426 information from the system 100, and thereafter takes and transmits 428 recipe edits, on the user device 160 to the recipe information 180, accepting the edits from the user 166, if any, and transmitting 428 the edits to the system 100. In some aspects of the present invention, the user 166 may input 427 additional information on ingredients and nutritional information, including but not limited to information on ingredients not present in the recipe information 180, and the user device 160 takes and transmits 428 to the system 100 such additional information along with the recipe edits.

In the UD nutritional assessment method module 430, the user device 160 receives ingredient matches 432 from the system 100 and presents them to the user 166. The user 166 may then select one or more of the plurality of ingredients 184 as the plurality of ingredients 184 that belong in the recipe information 180, and the user device 160 then sends a user selection 434 of the plurality of ingredients 184 to the system. Later, the user device 160 receives 436 nutritional information 182, the nutritional information 182 being the assessed information for the recipe and ingredients as selected by the user 166. In some aspects of the present invention, the user 166 may thereafter again input 427 additional information on ingredients and nutritional information, including but not limited to information on ingredients not already present in the plurality of ingredients 184 or in the user selection 434.

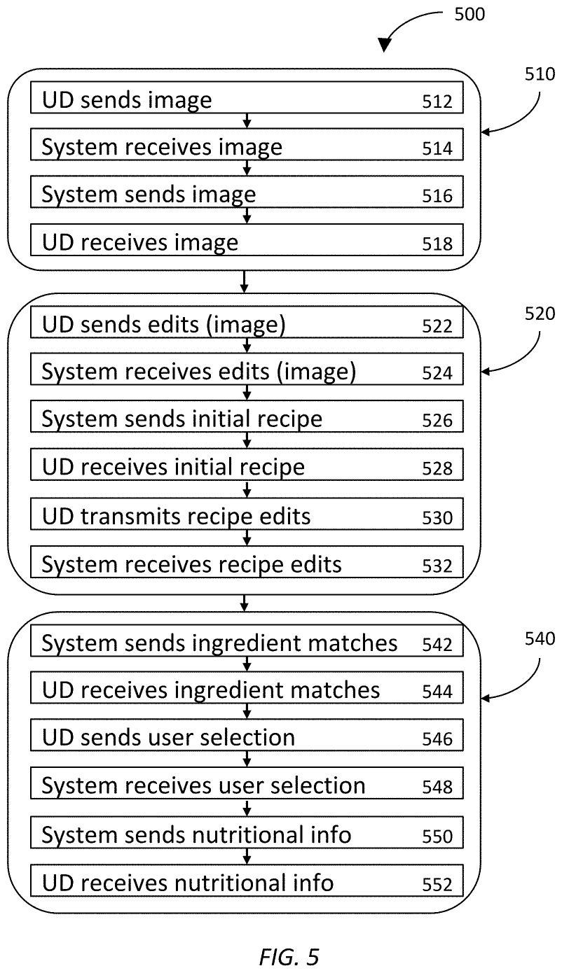

With reference to FIG. 5, the inventive method 500 of the present invention is presented from the perspective of a third party observing interactions between the system 100 and a user device 160. The method 500 comprises a third-party-view acquisition method module 510, a third-party-view image assessment method module 520, and a third-party-view nutritional assessment method module 540. The third-party-view acquisition method module 510 comprises steps in which the user device 160 sends 512 an image 168, and thereafter, the system 100 receives 514 the image 168. Then, the system 100 sends 516 an image 168 to the user device 160, and the user device 160 receives 518 the image 168. Thereafter, the system 100 sends 516 an image 168, and the user device 160 receives 518 the image 168. The third-party-view image assessment method module 520 comprises steps of the user device 160 sends 522 edits of the image 168 to the system 100, and then the system 100 receives 524 edits of the image 168. Thereafter, the system 100 sends 526 an initial recipe to the user device 160, and the user device 160 receives 528 the initial recipe from the system 100. Later, the user device 160 transmits 530 recipe edits to the system 100, which recipe edits may in some aspects of the present invention comprise user input of additional information on ingredients and nutritional information, including but not limited to information on ingredients not present in the initial recipe, and the system 100 receives 532 the recipe edits from the user device 160.

The third-party-view nutritional assessment method module 540 comprises steps in which the system 100 sends 542 ingredient matches to the user device 160, and the user device 160 receives 544 ingredient matches from the system 100. Thereafter, the user device 160 sends 546 the user selection 434 of ingredients from the plurality of ingredients 184, which may in some aspects of the present invention comprise additional information on ingredients and nutritional information, including but not limited to information on ingredients not already present in the plurality of ingredients 184 or in the user selection 434, and the system 100 receives 548 the user selection 434 of the plurality of ingredients 184. Later, the system 100 sends 550 nutritional information 182 to the user device 160, and the user device 160 receives 552 nutritional information 182 from the system 100.

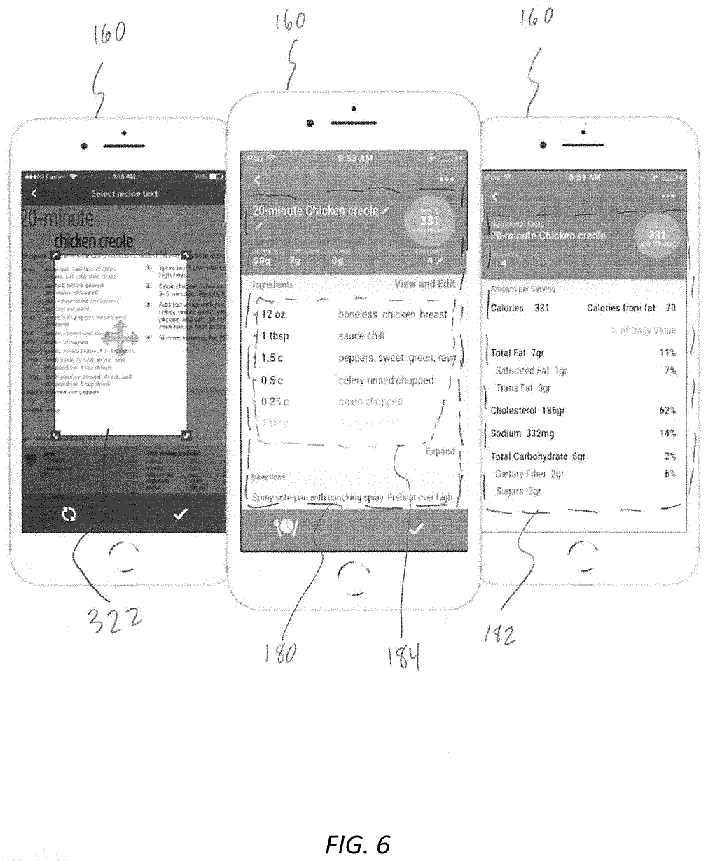

FIG. 6 depicts elements of the system 100 and methods 200, 300, 400, and 500, as they are used on an exemplary one or more user devices 160. On an exemplary user device 160, the user 166 may make some marking 322 to indicate the area of the image 168 that is of interest to the user 166 for the recipe information 180. An exemplary user device 160 may present the recipe information 180, either as an image or in a display of text and images after it has been captured by OCR technology and/or by edits. And an exemplary user device 160 may display nutritional information 182.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing devices referred to here, also referred to as a one or more processors, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory or computer memory referred to herein may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2,Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain aspects of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method, stored in non-transitory computer-readable media, for a system providing nutritional information from recipe images, by acquiring images with a system image acquisition method module, assessing images with a system image assessment method module, and assessing nutritional information with a system nutritional assessment method module, the method comprising:
the system acquires an image, and displays the image to a user device used by a user; then
the system carries out first a marking step, in which the system accepts some marking of an area of the image; then
the system performs OCR on the relevant area, generating a plurality of ingredients as recipe information; then
the system performs proofing on the recipe information; then
the system presents the recipe information to the user device; and then
the system accepts edits to the recipe information from the user device.

2. The method of claim 1, in which the system conducts conversions to change the amounts of each ingredient in the plurality of ingredients between one or more systems of measurement.

3. The method of claim 1, in which the system disambiguates amounts which are relative terms.

4. The method of claim 1, in which the user inputs additional information on ingredients and nutritional information, including but not limited to information on ingredients not present in the recipe information, and the system accepts such additional information.

5. The method of claim 1, in which after the system accepts edits to the recipe information from the user device,
the system checks the content of the recipe information; then
the system searches for each ingredient from the plurality of ingredients, and thereafter accepts edits to each ingredient from the plurality of ingredients; then
the system calculates nutritional information from information in one or more of the databases, the first external database, the second external database, and any other external databases; thereafter,
the system presents the nutritional information for the recipe information to the user using the user device.

6. A method, stored in non-transitory computer-readable media, for a user device to provide nutritional information from recipe images, by acquiring images with a UD image acquisition method module, assessing images with a UD image assessment method module, and assessing nutritional information with a UD nutritional assessment method module, the method comprising:
the user device sends an image to the system, and thereafter receives an image from the system; then
the user device takes edits of the image from a user of the user device, and then transmits edits of the image to the system; and then
the user device receives initial recipe information from the system, and thereafter takes and transmits recipe edits, to the recipe information, to the system.

6. The method of claim 6, in which the user inputs additional information on ingredients and nutritional information, including but not limited to information on ingredients not present in the recipe information, and the user device takes and transmits to the system such additional information along with the recipe edits.

8. The method of claim 6, in which the edits of the image from a user comprise marking by the user to indicate the area of the image that is of interest to the user for the recipe information.

9. The method of claim 6, in which, after the user device takes and transmits recipe edits, to the recipe information, to the system,
the user device receives ingredient matches from the system and presents them to the user; then
the user may select one or more of the plurality of ingredients as the plurality of ingredients that belong in the recipe information; then
the user device sends a user selection of the plurality of ingredients to the system; then
the user device receives nutritional information, the nutritional information being the assessed information for the recipe and ingredients as selected by the user.

10. A method, stored in non-transitory computer-readable media, for a user device and a system to provide nutritional information from recipe images, by acquiring images with a third-party-view acquisition method module, assessing images with a third-party-view image assessment method module, and assessing nutritional information with a third-party-view nutritional assessment method module, the method comprising:
the user device sends an image, and thereafter, the system receives the image; then
the system sends an image to the user device, and the user device receives the image; thereafter
the system sends an image, and the user device receives the image; then
the user device sends edits of the image to the system, and the system receives edits of the image; thereafter
the system sends an initial recipe to the user device, and the user device receives the initial recipe from the system; later,
the user device transmits recipe edits to the system, and the system receives the recipe edits from the user device.

11. The method of claim 10, in which, after the system receives the recipe edits from the user device,
the system sends ingredient matches to the user device, and the user device receives ingredient matches from the system, thereafter,
the user device sends the user selection of ingredients from the plurality of ingredients, and the system receives the user selection of the plurality of ingredients; then
the system sends nutritional information to the user device, and the user device receives nutritional information from the system.

12. The method of claim 11, in which the user selection of ingredients from the plurality of ingredients comprise additional information on ingredients and nutritional information, including but not limited to information on ingredients not already present in the plurality of ingredients or in the user selection.

13. The method of claim 10, in which the recipe edits comprise user input of additional information on ingredients and nutritional information, including but not limited to information on ingredients not present in the initial recipe.

14. A system for providing nutritional information from recipe images, the system comprising at least one processor, at least one database, at least one memory, at least one input/output port, and computer-readable instructions stored in non-transitory computer-readable media configured to carry out the various elements of the inventive methods; and wherein:
the database contains nutritional information related to a plurality of ingredients;
the system communicates with at least one user device, which user device acquires an image of a recipe;
the system obtains recipe information from the image using optical character recognition technology;
the system communicates with a first external database, a second external database, or any number of external databases, which external databases contain nutritional information.

15. The system of claim 14, in which the user device accesses the Internet using web-browsing software that is built as part of the system.

16. The system of claim 14, in which the image of a recipe is a photograph taken by the user device.

17. The system of claim 14, in which the image of a recipe is a photograph taken an external camera connected to the user device.

18. The system of claim 14, in which the image of a recipe is an image already present on the user device or accessed by the user device.

19. The system of claim 14, in which the image of a recipe is accessed on the Internet by the user device.

20. Computer-readable instructions, stored in non-transitory computer-readable media, for providing nutritional information from recipe images, the computer-readable instructions comprising controlling a system and a user device to take a recipe image, comprising recipe information, scan the recipe image for a plurality of recipe information, using optical character recognition technology, and use the recipe information and one or more databases of nutritional information to ascribe nutritional information to the recipe.
